(19) United States
(12) Patent Application Publication
(10) Pub. No.: US 2007/0064929 A1
(43) Pub. Date: Mar. 22, 2007

(54) Method of protecting a cryptographic algorithm

(76) Inventors: Vincent Carlier, Orsay (FR); Herve Chabanne, Mantes La Jolie (FR); Emmanuelle Dottax, Paris (FR)

Correspondence Address: BIRCH STEWART KOLASCH & BIRCH, PO BOX 747, FALLS CHURCH, VA, 22040-0747, US

(21) Appl. No.: 10/574,909

(22) PCT Filed: Oct. 12, 2004
(86) PCT No.: PCT/FR04/02579

§ 371 Date: Apr. 6, 2006

(30) Foreign Application Priority Data
Oct. 17, 2003 (FR) 0312152

(51) Int. Cl. H04L 9/28

(52) U.S. Cl. 380/28

(57) ABSTRACT

The method of protecting an algorithm that can be decomposed into the form of initial polynomials (Pi) of at least two variables and of degree not less than two, comprises the steps of making combined polynomials (Qk) each obtained from at least two initial polynomials (Pi, Pi+1), and of storing the combined polynomials (Qk) in the form of a configuration file in a memory (3) associated with a processor unit (4).

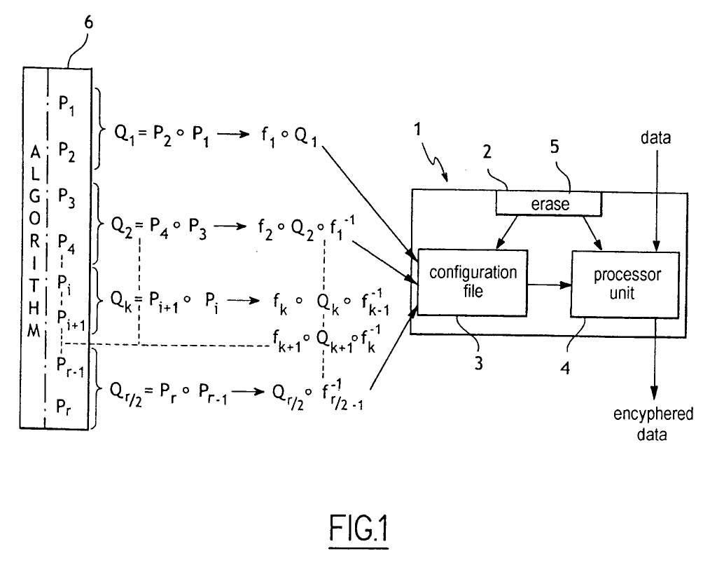

The present invention relates to a method of protecting a cryptographic algorithm.

### BACKGROUND OF THE INVENTION

It is known that the most effective way of conserving confidentiality during data transmission is to encrypt the data by means of a cryptographic algorithm.

For this purpose, devices are known that comprise a programmable processor unit associated with a configuration file including a personalized cryptographic algorithm. The entity implementing the personalized cryptographic algorithm is a generally different from the entity implementing the device that makes use of the cryptographic algorithm. In order to protect the cryptographic algorithm while in transport from the place where it was made to the place where it is to be loaded into the device for which it is intended, it is common practice to encipher the algorithm itself by using a protective key. While in this enciphered form, the cryptographic algorithm cannot be executed by the device for which it is intended. While the cryptographic algorithm is being loaded into the device for which it is intended, it is therefore necessary to perform deciphering in the processor unit by using the protective key which has been communicated by the manufacturer of the device and input by the manufacturer into the processor unit. Since the manufacturer of the device has access to the protective key, it is possible for a fraudster who manages to obtain both the enciphered cryptographic algorithm and the key held by the manufacturer of the device, to decipher the cryptographic algorithm, thus making it possible for said algorithm to be reconstituted. In addition, once it has been deciphered, the algorithm is no longer protected, which means that it is absolutely essential to have special security means for protecting the processor unit while performing the algorithm.

### OBJECT OF THE INVENTION

An object of the invention is to propose a method of protecting a cryptographic algorithm, including while it is being executed in a processor unit, without it being necessary for the manufacturer of the processor unit to intervene.

### BRIEF DESCRIPTION OF THE INVENTION

In order to achieve this object, the invention provides a method of protecting a cryptographic algorithm that is separable into the form of initial polynomials of at least two variables each, and having a degree of not less than two, the method comprising the steps of providing combined polynomials each obtained from at least two initial polynomials, and of implementing the combined polynomials in the processor unit.

Thus, by combining at least two initial polynomials each of degree not less than two, a polynomial is produced of degree not less than four, of components that it is extremely difficult to find, in particular when the number of variables in these polynomials is sufficiently large. The algorithm as transformed in this way is thus protected and can therefore be transmitted with a satisfactory degree of security. Furthermore, the combined polynomials can be executed directly in the same manner as the initial polynomials. No transformation is needed while configuring the processor unit, so the algorithm remains protected while it is being executed.

In an advantageous version of the invention, in the event of an intrusion into the device, erasure is implemented of part of the processor unit, and of the memory containing the configuration file when the configuration is present. Once even only a little of the information is missing, the difficulty in reconstituting the algorithm is considerably increased, and as a result partial erasure alone suffices to protect the algorithm.

In another advantageous aspect of the invention, the method further includes the step of combining each combined polynomial with a function, and of combining the following combined polynomial with an inverse function. This additional transformation further increases the difficulty in finding the initial polynomial, while not harming the executable nature of the combined polynomial because of a forward function being eliminated by the corresponding inverse function when going from one combined polynomial to the following combined polynomial.

The function combined with each combined polynomial is preferably a linear function. In which case, the degree of the combined polynomial remains unchanged, such that the memory space occupied by the combined polynomial itself remains unchanged.

### BRIEF DESCRIPTION OF THE DRAWING

Other characteristics and advantages of the invention appear on reading the following detailed description of a particular and non-limiting implementation of the invention given with a reference to the sole accompanying FIGURE which is a diagram showing the method of the invention.

### MORE DETAILED DESCRIPTION

With reference to the FIGURE, the method of the invention for protecting a cryptographic algorithm is for implementing in an enciphering device 1 comprising in conventional manner a unit 2 in which there is disposed a volatile memory 3 for containing a configuration file and connected to a processor unit 4 that is configurable by the configuration file in order to encipher data input into the device.

Also in conventional manner, the device 1 includes an eraser member 5 connected to the memory 3 and to the processor unit 4, in order to act in the event of an intrusion to erase at least some of the data contained therein. To this end, the memory and the processor unit 4 are preferably volatile, so that even a short interruption of their power supply leads to some of the data contained in the memory and/or the processor unit being erased.

According to the invention, the cryptographic algorithm 6 for inputting into the configuration file 3 is initially subdivided by a conventional method into rounds represented by initial polynomials P₁, P₂, P₃, P₄, . . . , Pᵢ, Pᵢ₊₁, . . . , Pᵣ₋₁, Pᵣ, each having a plurality of variables and a degree of not less than two. The initial polynomials are determined by using keys that are different (unless repeated by chance), or by using different subkeys of a single key. The keys or the subkeys may be totally integrated in the polynomials or they may constitute additional variables within the polynomials. The initial polynomials Pᵢ are then combined in pairs in the implementation shown using a mathematical combination of functions in order to obtain combined polynomials Q₁=P₂ o P₁, Q₂=P₄ o P₃, . . . , Qₖ=Pᵢ₊₁ o Pᵢ, . . . , Q_{r/2}=Pᵣ o Pᵣ₋₁. When the polynomials Pᵢ are of degree two, the combined polynomials Qₖ as obtained in this way are of degree four.

In the preferred implementation shown, each polynomial Qₖ is also combined with a function fₖ that is preferably a linear function, and the following combined function is combined in corresponding manner with the inverse function fₖ⁻¹, naturally with the exception of the first and last combined polynomials, one of which is combined with a forward function and the other with an inverse function.

Before being loaded into the memory 3 in the form of a configuration file, the cryptographic algorithm is thus represented by the polynomial functions f₁ o Q₁, f₂ o Q₂ o f₁⁻¹, . . . , fₖ o Qₖ o fₖ₋₁⁻¹, fₖ₊₁ o Qₖ₊₁ o fₖ⁻¹, . . . , Q_{r/2} o f_{r/2-}⁻¹.

Naturally, the invention is not limited to the implementation described, and variants can be applied thereto without going beyond the ambit of the invention as defined by the claims.

In the particular, although the initial rounds are shown in the form of a single initial polynomial per round, each round may contain a plurality of initial polynomials. The initial polynomials can thus be combined within any given round or by combining a plurality of rounds with one another.

Although the method is described with reference to a device comprising a processor unit 4 associated with a memory 3 for receiving the algorithm of the form of a configuration file, thus making it possible to modify the configuration without it being necessary to return the device of the workshop, it is possible to provide for the algorithm to be implemented directly in the processor unit by the processor unit being configured in the workshop. Under such circumstances, the configuration can no longer be modified without returning to the workshop.

Although the method of invention is described by combining the initial polynomials two by two, it can be necessary with some algorithms to group the individual polynomials using a number greater than two. For example, with the algorithm known as the DES algorithm, in which the rounds are interleaved, it is necessary to combine more than two initial polynomials in order to obtain combined polynomials that can be executed reliably using the method described above.

Although the invention is described as including a step comprising combination with a function and with the inverse function, it is possible to make up the configuration file solely from combined polynomials Qₖ.

Instead of combining various combined polynomials Qₖ with different functions fₖ for each of the combined polynomials Qₖ as described above, each combined polynomial may be combined with the same function f and then with the inverse function f⁻¹.

What is claimed is:

1. A method of protecting a cryptographic algorithm (6) for execution in a device (1) comprising programmable processor unit (4), the algorithm being separable into the form of initial polynomials (Pᵢ) of at least two variables each, and having a degree of not less than two, the method comprising the steps of providing combined polynomials (Qₖ) each obtained from at least two initial polynomials (Pᵢ, Pᵢ₊₁), and of implementing the combined polynomials (Qₖ) in the programmable processor unit (4).

2. A method according to claim 1, further comprising the step of storing the combined polynomials (Qₖ) in the form of a configuration file that is loaded into a memory (3) associated with the processor unit (4).

3. A method according to claim 2, wherein the memory (3) and the programmable processor unit (4) are associated with an eraser member (5) serving, in the event of an intrusion into the device, to erase the processor unit (4), and to erase the memory (3) containing the configuration file when the configuration is present in said memory.

4. A method according to claim 1, including the step of combining each combined polynomial (Qₖ) with a function (fₖ), and of combining the following combined polynomial (Qₖ₊₁) with an inverse function (fₖ⁻¹).

5. A method according to claim 4, wherein the function (fₖ) combined with each combined polynomial (Qₖ) is a linear feature.
